(19) United States
(12) Patent Application Publication
(10) Pub. No.: US 2006/0267679 A1
(43) Pub. Date: Nov. 30, 2006

(54) Operational amplifier, driver circuit, and electro-optical device

(75) Inventor: Kazuhiro Maekawa, Chino-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 11/432,316

(22) Filed: May 12, 2006

(30) Foreign Application Priority Data
May 24, 2005 (JP) 2005-151090

(51) Int. Cl. G06G 7/12

(52) U.S. Cl. 327/561

(57) ABSTRACT

An operational amplifier 100 includes a differential amplifier 110 which includes an N-type differential transistor pair DIF1 to which an input voltage Vin and an output voltage Vout are supplied at respective gates, and an N-type current source transistor CS1 which generates the sum of drain currents of the transistors QN1 and QN2 making up the differential transistor pair DIF1, and amplifies the difference between the input voltage and the output voltage, and a P-type driver transistor DQP1 which is provided on a high potential power supply side, is gate-controlled based on voltage of an output node of the differential amplifier 110, and generates a drain voltage as the output voltage Vout. The current source transistor CS1 is a transistor in which a potential of an impurity layer in which a channel region is formed is set independently of a potential of an impurity layer in which channel regions of other transistors are formed.

Japanese Patent Application No. 2005-151090 filed on May 24, 2005, is hereby incorporated by reference in its entirety.

### BACKGROUND OF THE INVENTION

The present invention relates to an operational amplifier, a driver circuit, and an electro-optical device.

As a liquid crystal panel (electro-optical device in a broad sense) used for an electronic instrument such as a portable telephone, a simple matrix type liquid crystal panel and an active matrix type liquid crystal panel using a switching device such as a thin film transistor (hereinafter abbreviated as “TFT”) are known.

The simple matrix type liquid crystal panel allows power consumption to be easily reduced in comparison with the active matrix type liquid crystal panel. However, the simple matrix type liquid crystal panel has disadvantages in that it is difficult to increase the number of colors and to display a video image. The active matrix type liquid crystal panel is suitable for increasing the number of colors and displaying a video image. However, the active matrix type liquid crystal panel has a disadvantage in that it is difficult to reduce power consumption.

In recent years, a multicolor video image display has been increasingly demanded for a portable electronic instrument such as a portable telephone in order to provide a high-quality image. Therefore, the active matrix type liquid crystal panel has been increasingly used instead of the simple matrix type liquid crystal panel.

In the active matrix type liquid crystal panel, it is desirable to provide an operational amplifier functioning as an output buffer in a data line driver circuit which drives data lines of the liquid crystal panel.

For example, when displaying 64 grayscales per dot using a liquid crystal panel, it is necessary to generate 64 grayscale voltages by dividing a voltage having an amplitude of 5 V. Therefore, it becomes difficult to accurately generate the grayscale voltages as the amplitude of the voltage is decreased from 5 V, whereby the grayscale representation may be impaired.

However, an operational amplifier which performs a class AB amplification operation (hereinafter called “class AB operational amplifier”) as disclosed in JP-A-2003-157054 has a problem relating to an input dead zone. In the class AB operational amplifier, a driver transistor of a driver section cannot be controlled when an input signal in the input dead zone is input, whereby occurrence of a shoot-through current cannot be prevented. This causes deterioration of circuit stability and an increase in power consumption.

An additional circuit or the like may be provided in order to eliminate the problem caused by the input dead zone. However, this may result in an increase in development cost and circuit scale.

In order to reduce power consumption, it is desirable that the driver circuit drive the data line using an operational amplifier having an output voltage range equal to the operating power supply voltage range. In more detail, it is desirable that the operational amplifier perform a rail-to-rail operation. However, even if the rail-to-rail operation is realized by providing an additional circuit, an increase in development cost, circuit scale, and power consumption due to the addition of a current source occurs, whereby cost may be increased.

### SUMMARY

A first aspect of the invention relates to an operational amplifier comprising:

a differential amplifier which includes an N-type differential transistor pair to which an input voltage and an output voltage are supplied at respective gates, and an N-type current source transistor which generates the sum of drain currents of the transistors making up the differential transistor pair, and amplifies a difference between the input voltage and the output voltage; and

a P-type driver transistor which is provided on a high potential power supply side, is gate-controlled based on voltage of an output node of the differential amplifier, and generates a drain voltage as the output voltage;

the current source transistor being a transistor in which a potential of an impurity layer in which a channel region is formed is set independently of a potential of an impurity layer in which channel regions of other transistors are formed.

A second aspect of the invention relates to an operational amplifier comprising:

a first differential amplifier which includes an N-type first differential transistor pair to which an input voltage and an output voltage are supplied at respective gates, and an N-type first current source transistor which generates the sum of drain currents of the transistors making up the differential transistor pair, and amplifies a difference between the input voltage and the output voltage;

a second differential amplifier which includes a P-type second differential transistor pair to which the input voltage and the output voltage are supplied at respective gates, and a P-type second current source transistor which generates the sum of drain currents of the transistors making up the second differential transistor pair, and amplifies a difference between the input voltage and the output voltage;

a P-type first driver transistor which is provided on a high potential power supply side, is gate-controlled based on voltage of an output node of the first differential amplifier, and generates a drain voltage as the output voltage; and

an N-type second driver transistor which is provided on a low potential power supply side, is gate-controlled based on voltage of an output node of the second differential amplifier, and generates a drain voltage as the output voltage;

the first current source transistor of the first current source transistor and the second current source transistor being a transistor in which a potential of an impurity layer in which a channel region is formed is set independently of a potential of an impurity layer in which channel regions of other transistors are formed.

A third aspect of the invention relates to a driver circuit for driving an electro-optical device including a plurality of scan lines, a plurality of data lines, and pixel electrodes specified by the scan lines and the data lines, the driver circuit comprising:

a data voltage generation circuit which generates a data voltage in units of the data lines; and the above operational amplifier which is provided in units of the data lines and drives the data line based on the data voltage generated by the data voltage generation circuit.

A fourth aspect of the invention relates to an electro-optical device comprising:

a plurality of scan lines;

a plurality of data lines;

a plurality of pixel electrodes;

a scan line driver circuit which scans the scan lines; and

the above driver circuit which drives the data lines.

### BRIEF DESCRIPTION OF THE SEVERAL VIEWS OF THE DRAWING

FIG. 1 is a block diagram of a configuration example of a display device including an electro-optical device according to one embodiment of the invention.

FIG. 2 is a block diagram of another configuration example of a display device according to one embodiment of the invention.

FIG. 3 is a block diagram of a configuration example of a data line driver circuit shown in FIG. 1 or 2.

FIG. 4 is a block diagram of a configuration example of a scan line driver circuit shown in FIG. 1 or 2.

FIG. 5 is a circuit diagram of an operational amplifier according to a first configuration example of one embodiment of the invention.

FIGS. 6A and 6B are schematic cross-sectional diagrams of transistors having a twin-well structure.

FIG. 7 is a schematic cross-sectional diagram of a current source transistor shown in FIG. 5.

FIG. 8 is a diagram illustrative of the output voltage range of the operational amplifier according to the first configuration example of one embodiment of the invention.

FIG. 9 is a circuit diagram of an operational amplifier according to a modification of the first configuration example.

FIGS. 10A and 10B are schematic cross-sectional diagrams of transistors having a twin-well structure.

FIG. 11 is a schematic cross-sectional diagram of a current source transistor shown in FIG. 9.

FIG. 12 is a circuit diagram of an operational amplifier according to a second configuration example of one embodiment of the invention.

FIG. 13 is a diagram illustrative of the output voltage range of the operational amplifier according to the second configuration example of one embodiment of the invention.

FIG. 14 is a circuit diagram of an operational amplifier according to a first modification of the second configuration example.

FIG. 15 is a schematic cross-sectional diagram of a current source transistor shown in FIG. 14.

FIG. 16 is a circuit diagram of an operational amplifier according to a second modification of the second configuration example.

FIG. 17 is a circuit diagram of an operational amplifier according to a third modification of the second configuration example.

FIG. 18 is a schematic cross-sectional diagram of a current source transistor shown in FIG. 17.

### DETAILED DESCRIPTION OF THE EMBODIMENT

The invention may provide an operational amplifier which allows an increase in the output voltage range at a low power consumption without increasing the circuit scale, a driver circuit, and an electro-optical device.

One embodiment of the invention relates to an operational amplifier comprising:

a differential amplifier which includes an N-type differential transistor pair to which an input voltage and an output voltage are supplied at respective gates, and an N-type current source transistor which generates the sum of drain currents of the transistors making up the differential transistor pair, and amplifies a difference between the input voltage and the output voltage; and

a P-type driver transistor which is provided on a high potential power supply side, is gate-controlled based on voltage of an output node of the differential amplifier, and generates a drain voltage as the output voltage;

the current source transistor being a transistor in which a potential of an impurity layer in which a channel region is formed is set independently of a potential of an impurity layer in which channel regions of other transistors are formed.

In the operational amplifier according to this embodiment, the impurity layer in which the channel region of the current source transistor is formed may be set at a potential lower than a potential of a ground power supply.

In the operational amplifier according to this embodiment, the impurity layer in which the channel region of the current source transistor is formed may be set at a potential lower than the potential of the ground power supply in an amount equal to or greater than a threshold voltage of the transistor making up the differential transistor pair.

According to the above embodiment, a large amount of current can be generated in comparison with a transistor having a twin-well structure in which a potential of an impurity layer in which a channel region is formed cannot be set independently of a potential of an impurity layer in which channel regions of other transistors. Therefore, even if the input voltage supplied to the gate electrode of the N-type transistor making up the differential transistor pair of the differential amplifier is lower than the threshold voltage of the transistor based on the source voltage of the transistor, the drain current of the transistor can be generated to allow a transistor operation. As a result, the potential of the input dead zone of the transistor making up the differential transistor pair can be decreased, whereby the output voltage range can be increased.

Moreover, an increase in the number of current paths can be prevented in comparison with the case of providing an additional circuit, whereby an increase in current consumption can be prevented.

Therefore, according to the above embodiment, an operational amplifier which allows an increase in the output voltage range at a low power consumption without increasing the circuit scale can be provided.

Another embodiment of the invention relates to an operational amplifier comprising:

a first differential amplifier which includes an N-type first differential transistor pair to which an input voltage and an output voltage are supplied at respective gates, and an N-type first current source transistor which generates the sum of drain currents of the transistors making up the differential transistor pair, and amplifies a difference between the input voltage and the output voltage;

a second differential amplifier which includes a P-type second differential transistor pair to which the input voltage and the output voltage are supplied at respective gates, and a P-type second current source transistor which generates the sum of drain currents of the transistors making up the second differential transistor pair, and amplifies a difference between the input voltage and the output voltage;

a P-type first driver transistor which is provided on a high potential power supply side, is gate-controlled based on voltage of an output node of the first differential amplifier, and generates a drain voltage as the output voltage; and

an N-type second driver transistor which is provided on a low potential power supply side, is gate-controlled based on voltage of an output node of the second differential amplifier, and generates a drain voltage as the output voltage;

the first current source transistor of the first current source transistor and the second current source transistor being a transistor in which a potential of an impurity layer in which a channel region is formed is set independently of a potential of an impurity layer in which channel regions of other transistors are formed.

In the operational amplifier according to this embodiment, the impurity layer in which the channel region of the first current source transistor is formed may be set at a potential lower than a potential of a ground power supply.

In the operational amplifier according to this embodiment, the impurity layer in which the channel region of the first current source transistor is formed may be set at a potential lower than the potential of the ground power supply in an amount equal to or greater than a threshold voltage of the transistor making up the first differential transistor pair.

According to the above embodiment, a large amount of current can be generated in comparison with a transistor having a twin-well structure in which a potential of an impurity layer in which a channel region is formed cannot be set independently of a potential of an impurity layer in which channel regions of other transistors. Therefore, even if the input voltage supplied to the gate electrode of the N-type transistor making up the differential transistor pair of the differential amplifier is lower than the threshold voltage of the transistor based on the source voltage of the transistor, the drain current of the transistor can be generated to allow a transistor operation. As a result, the potential of the input dead zone of the transistor making up the N-type differential transistor pair can be decreased.

Moreover, since the high-potential-side voltage of the P-type transistor making up the second differential transistor pair can be increased within the breakdown voltage range, even if the input voltage is in the input dead zone on the high potential side, the drain current of the transistor can be generated to allow a transistor operation. Therefore, the potential of the input dead zone of the transistor making up the P-type differential transistor pair can be increased.

As a result, according to the above embodiment, the output voltage range can be increased.

Moreover, an increase in the number of current paths can be prevented in comparison with the case of providing an additional circuit, whereby an increase in current consumption can be prevented.

Therefore, according to the above embodiment, an operational amplifier which allows an increase in the output voltage range at a low power consumption without increasing the circuit scale can be provided.

In the operational amplifier according to this embodiment, the second current source transistor may be a transistor in which a potential of an impurity layer in which a channel region is formed is set independently of a potential of an impurity layer in which channel regions of other transistors are formed.

In a class AB operational amplifier, since the output voltage changes corresponding to the current drive capabilities of the first and second driver transistors, it is desirable that the rising edge and the falling edge of the output voltage be made uniform. According to this embodiment, since the operating currents of the differential amplifiers which control the current drive capabilities of the first and second driver transistors can be equalized, the current drive capabilities of the first and second driver transistors can be easily adjusted.

In the operational amplifier according to this embodiment, the transistor in which a potential of an impurity layer in which a channel region is formed is set independently of a potential of an impurity layer in which channel regions of other transistors are formed may be a transistor having a triple-well structure.

In the operational amplifier according to this embodiment, the transistor in which a potential of an impurity layer in which a channel region is formed is set independently of a potential of an impurity layer in which channel regions of other transistors are formed may be a transistor having an epitaxial wafer structure.

In the operational amplifier according to this embodiment, the transistor in which a potential of an impurity layer in which a channel region is formed is set independently of a potential of an impurity layer in which channel regions of other transistors are formed may be a transistor having a silicon-on-insulator (SOI) structure.

Another embodiment of the invention relates to a driver circuit for driving an electro-optical device including a plurality of scan lines, a plurality of data lines, and pixel electrodes specified by the scan lines and the data lines, the driver circuit comprising: a data voltage generation circuit which generates a data voltage in units of the data lines; and the above operational amplifier which is provided in units of the data lines and drives the data line based on the data voltage generated by the data voltage generation circuit.

According to this embodiment, a driver circuit can be provided which includes an operational amplifier which allows an increase in the output voltage range at a low power consumption without increasing the circuit scale.

A further embodiment of the invention relates to an electro-optical device comprising: a plurality of scan lines; a plurality of data lines; a plurality of pixel electrodes; a scan line driver circuit which scans the scan lines; and the above driver circuit which drives the data lines.

According to this embodiment, an electro-optical device can be provided which is driven by a driver circuit which includes an operational amplifier which allows an increase in the output voltage range at a low power consumption without increasing the circuit scale. Therefore, the size and the power consumption of the electro-optical device can be reduced.

The embodiments of the present invention are described below in detail with reference to the drawings. Note that the embodiments described below do not in any way limit the scope of the invention laid out in the claims. Note that all elements of the embodiments described below should not necessarily be taken as essential requirements for the invention.

1. Electro-Optical Device

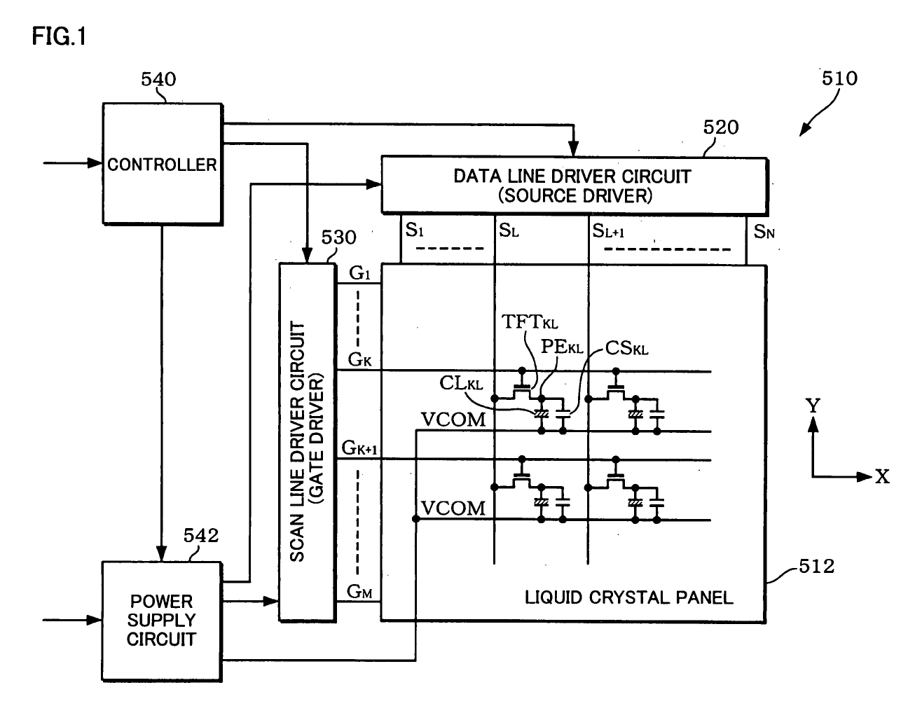

FIG. 1 is a block diagram of a configuration example of a display device including an electro-optical device according to one embodiment of the invention. The display device shown in FIG. 1 includes a driver circuit (data line driver circuit in FIG. 1) to which an operational amplifier according to this embodiment is applied, and realizes the function of a liquid crystal device. The electro-optical device according to this embodiment realizes the function of a liquid crystal panel.

A liquid crystal device 510 (display device in a broad sense) includes a liquid crystal panel 512 (display panel in a broad sense), a data line driver circuit 520 (source driver in a narrow sense), a scan line driver circuit 530 (gate driver in a narrow sense), a controller 540, and a power supply circuit 542. The liquid crystal device 510 need not necessarily include all of these circuit blocks. The liquid crystal device 510 may have a configuration in which some of these circuit blocks are omitted.

The liquid crystal panel 512 includes a plurality of scan lines (gate lines in a narrow sense), a plurality of data lines (source lines in a narrow sense), and pixels specified by the scan lines and the data lines. In this case, an active matrix type liquid crystal device may be formed by connecting a thin film transistor TFT (switching device in a broad sense) with the data line and connecting a pixel electrode with the thin film transistor TFT.

In more detail, the liquid crystal panel 512 is formed on an active matrix substrate (e.g. glass substrate). A plurality of scan lines G₁ to G_{M} (M is a natural number of two or more), arranged in a direction Y shown in FIG. 1 and extending in a direction X, and a plurality of data lines S₁ to S_{N} (N is a natural number of two or more), arranged in the direction X and extending in the direction Y, are disposed on the active matrix substrate. A thin film transistor TFT_{KL} (switching device in a broad sense) is provided at a position corresponding to the intersecting point of the scan line G_{K} (1≦K≦M, K is a natural number) and the data line S_{L} (1≦L≦N, L is a natural number).

A gate electrode of the thin film transistor TFT_{KL} is connected with the scan line G_{K}, a source electrode of the thin film transistor TFT_{KL} is connected with the data line S_{L}, and a drain electrode of the thin film transistor TFT_{KL} is connected with a pixel electrode PE_{KL}. A liquid crystal capacitor CL_{KL} (liquid crystal element) and a storage capacitor CS_{KL} are formed between the pixel electrode PE_{KL} and a common electrode VCOM which faces the pixel electrode PE_{KL} through a liquid crystal element (electro-optical substance in a broad sense). A liquid crystal is sealed between the active matrix substrate on which the thin film transistor TFT_{KL}, the pixel electrode PE_{KL}, and the like are formed and a common substrate on which the common electrode VCOM is formed. The transmissivity of the pixel changes corresponding to the voltage applied between the pixel electrode PE_{KL} and the common electrode VCOM.

A voltage applied to the common electrode VCOM is generated by the power supply circuit 542. The common electrode VCOM may be formed in a stripe pattern corresponding to each scan line instead of forming the common electrode COM over the common substrate.

The data line driver circuit 520 drives the data lines S₁ to S_{N} of the liquid crystal panel 512 based on grayscale data. The scan line driver circuit 530 sequentially scans the scan lines G₁ to G_{M} of the liquid crystal panel 512.

The controller 540 controls the data line driver circuit 520, the scan line driver circuit 530, and the power supply circuit 542 according to information set by a host such as a central processing unit (CPU) (not shown).

In more detail, the controller 540 sets an operation mode or supplies a vertical synchronization signal or a horizontal synchronization signal generated therein to the data line driver circuit 520 and the scan line driver circuit 530, and controls the polarity reversal timing of the voltage of the common electrode VCOM for the power supply circuit 542, for example.

The power supply circuit 542 generates voltages (grayscale voltage) necessary for driving the liquid crystal panel 512 and the voltage of the common electrode VCOM based on a reference voltage supplied from the outside.

In FIG. 1, the liquid crystal device 510 includes the controller 540. Note that the controller 540 may be provided outside the liquid crystal device 510. Or, the host may be included in the liquid crystal device 510 together with the controller 540.

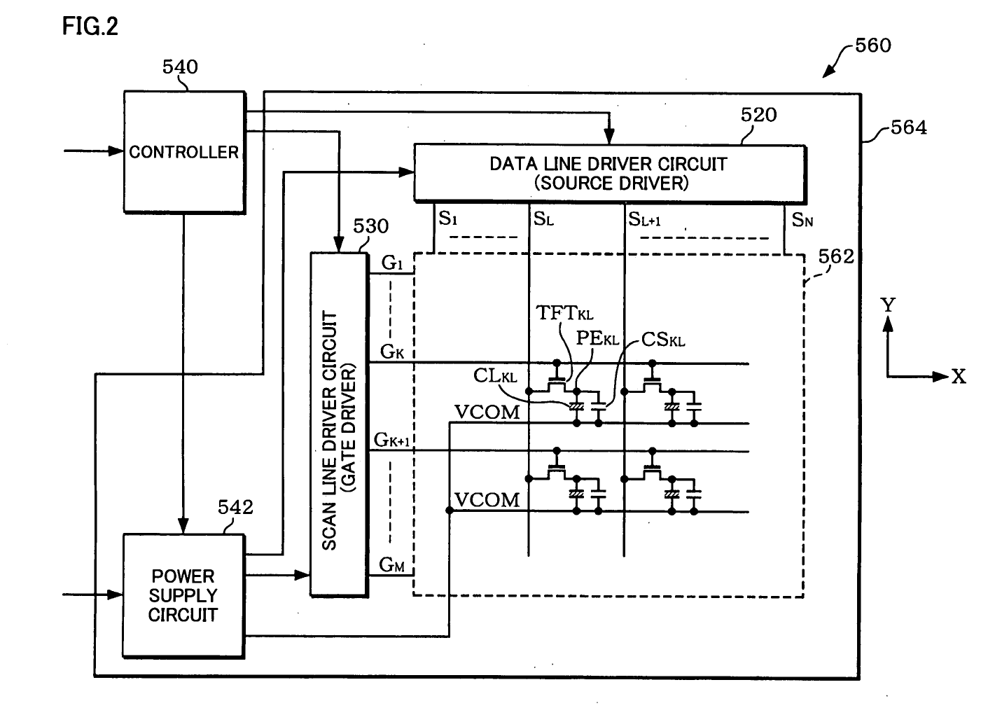

FIG. 2 is a block diagram of another configuration example of the display device according to this embodiment. In FIG. 2, the same sections as the sections shown in FIG. 1 are indicated by the same symbols. Description of these sections is appropriately omitted.

In a liquid crystal device 560 shown in FIG. 2, the data line driver circuit 520, the scan line driver circuit 530, and the power supply circuit 542 are formed on an active matrix substrate 564 in which pixels are formed in a pixel formation area 562 as described above. At least one of the data line driver circuit 520, the scan line driver circuit 530, and the power supply circuit 542 shown in FIG. 2 may be omitted from the circuit blocks formed on the active matrix substrate 564. Or, the controller 540 may be additionally formed on the active matrix substrate 564 shown in FIG. 2.

1.1 Data Line Driver Circuit

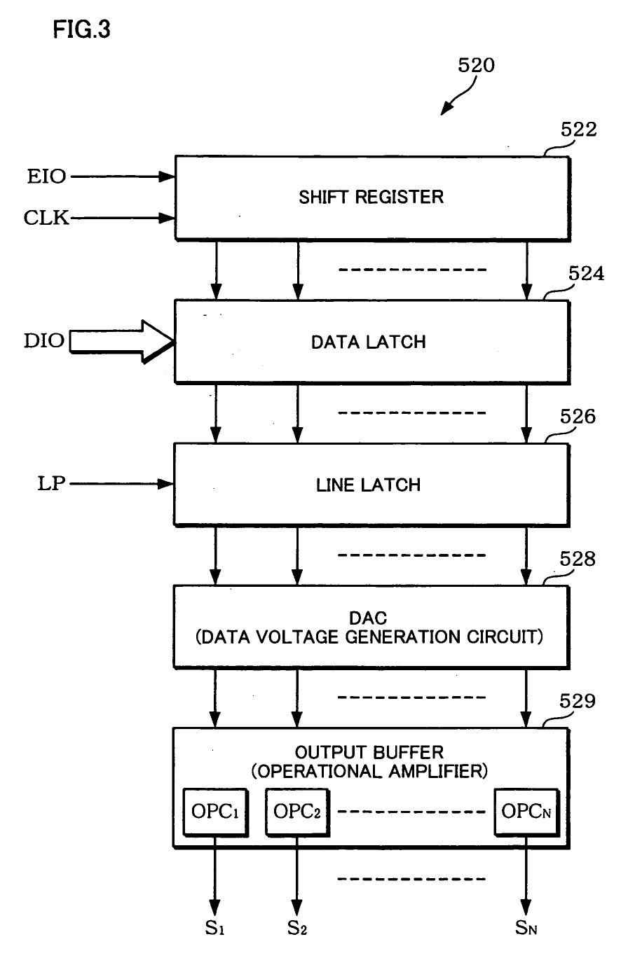

FIG. 3 shows a configuration example of the data line driver circuit 520 shown in FIG. 1 or 2.

The data line driver circuit 520 (driver circuit in a broad sense) includes a shift register 522, a data latch 524, a line latch 526, a DAC 528 (digital-analog conversion circuit; data voltage generation circuit in a broad sense), and an output buffer 529 (operational amplifier).

The shift register 522 includes a plurality of flip-flops provided corresponding to the data lines and sequentially connected. The shift register 522 holds an enable input-output signal EIO in synchronization with a clock signal CLK, and sequentially shifts the enable input-output signal EIO to the adjacent flip-flops in synchronization with the clock signal CLK.

Grayscale data (DIO) is input to the data latch 524 from the controller 540 in units of 18 bits (6 bits (grayscale data)×3 (each color of RGB)), for example. The data latch 524 latches the grayscale data (DIO) in synchronization with the enable input-output signal EIO sequentially shifted by the flip-flops of the shift register 522.

The line latch 526 latches the grayscale data in one horizontal scan unit latched by the data latch 524 in synchronization with a horizontal synchronization signal LP supplied from the controller 540.

The DAC 528 generates an analog data voltage supplied to the data line. In more detail, the DAC 528 selects one of grayscale voltages from the power supply circuit 542 shown in FIG. 1 or 2 based on the digital grayscale data from the line latch 526, and outputs an analog data voltage corresponding to the digital grayscale data.

The output buffer 529 buffers the data voltage from the DAC 528, and drives the data line by outputting the data voltage to the data line. In more detail, the output buffer 529 includes voltage-follower-connected operational amplifiers OPC₁ to OPC_{N} provided in data line units. The operational amplifier performs impedance conversion of the data voltage from the DAC 528, and outputs the resulting data voltage to the data line.

In FIG. 3, the digital grayscale data is subjected to digital-analog conversion and output to the data line through the output buffer 529. Note that an analog image signal may be sampled and held, and output to the data line through the output buffer 529.

1.2 Scan Line Driver Circuit

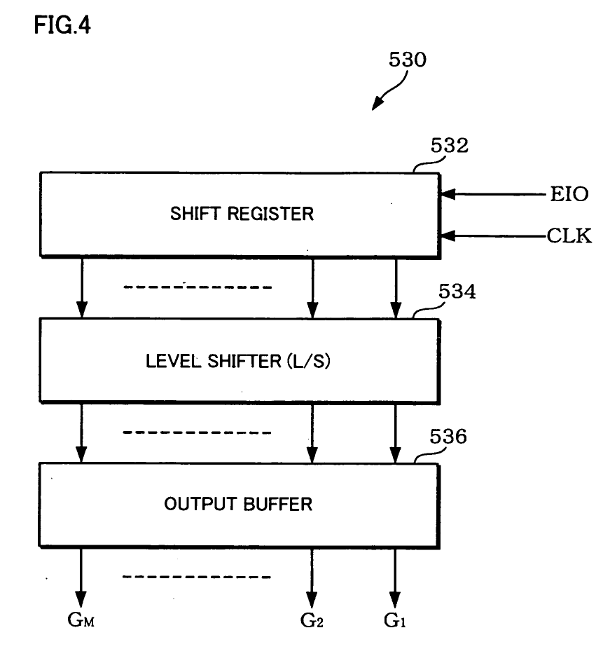

FIG. 4 shows a configuration example of the scan line driver circuit 530 shown in FIG. 1 or 2.

The scan line driver circuit 530 includes a shift register 532, a level shifter 534, and an output buffer 536.

The shift register 532 includes a plurality of flip-flops provided corresponding to the scan lines and sequentially connected. The shift register 532 holds the enable input-output signal EIO in the flip-flop in synchronization with the clock signal CLK, and sequentially shifts the enable input-output signal EIO to the adjacent flip-flops in synchronization with the clock signal CLK. The enable input-output signal EIO input to the shift register 532 is a vertical synchronization signal supplied from the controller 540.

The level shifter 534 shifts the level of the voltage from the shift register 532 to the voltage level corresponding to the liquid crystal element of the liquid crystal panel 512 and the transistor performance of the thin film transistor TFT. As the voltage level, a high voltage level of 20 to 50 V is necessary, for example.

The output buffer 536 buffers the scan voltage shifted by the level shifter 534, and drives the scan line by outputting the scan voltage to the scan line.

2. Operational Amplifier

In recent years, along with an increase in resolution of a display image or an increase in screen size of a liquid crystal panel, the number of data lines of a liquid crystal panel has been increased. If the number of data lines of a liquid crystal panel is increased, the distance between the adjacent data lines decreases, whereby the wiring capacitance increases. Therefore, it is necessary to use an operational amplifier having a high drive capability in order to drive the data lines within a specific period of time.

However, the operational amplifier consumes a large amount of power. Moreover, the operational amplifiers are provided in data line units as the output buffers, as described above. Therefore, it is necessary to provide an operational amplifier which realizes a reduction in power consumption without decreasing drive capability.

In order to decrease the power supply voltage level aiming at reducing power consumption and to increase the number of grayscales, it is necessary to increase the output voltage range of the operational amplifier.

An operational amplifier according to this embodiment described below allows an increase in the output voltage range at a low power consumption while minimizing an increase in the layout area without requiring an additional circuit.

2.1 First Configuration Example

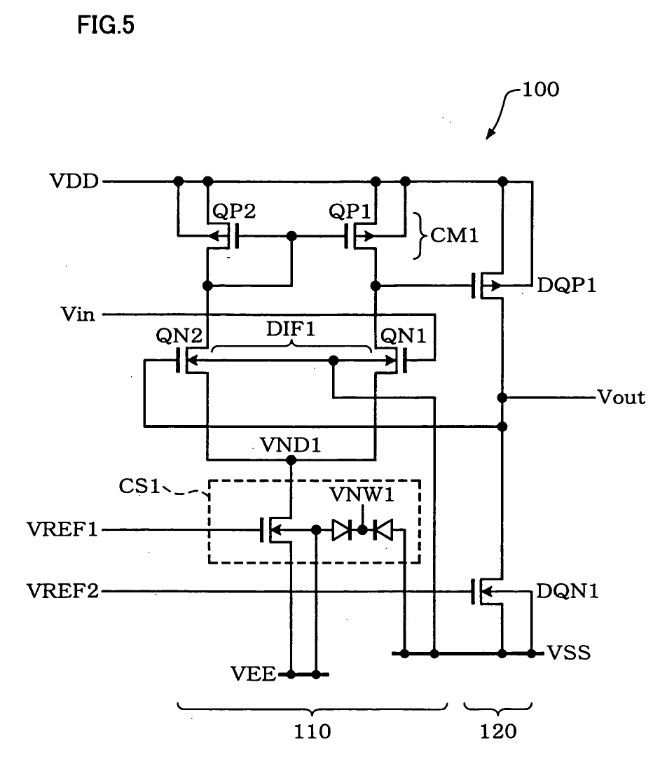

FIG. 5 is a circuit diagram of an operational amplifier according to a first configuration example of this embodiment.

An operational amplifier 100 shown in FIG. 5 is applied as one of the operational amplifiers OPC₁ to OPC_{N} shown in FIG. 3. In this case, an input voltage Vin is the data voltage generated by the DAC 528, and an output voltage Vout is the drive voltage supplied to the data line.

The operational amplifier 100 includes an N-type (second conductivity type in a broad sense) differential amplifier 110 and an output circuit 120. The differential amplifier 110 and the output circuit 120 are formed on a P-type (first conductivity type in a broad sense) semiconductor substrate. The operational amplifier 100 is an operational amplifier which performs a class A amplification operation (hereinafter called “class A operational amplifier”).

In more detail, the differential amplifier 110 includes an N-type differential transistor pair DIF1 (first differential transistor pair), a current mirror circuit CM1, and a current source transistor CS1 (first current source transistor). The differential transistor pair DIF1 includes N-type metal-oxide-semiconductor (MOS) transistors (MOS transistor is hereinafter called “transistor”) QN1 and QN2. The input voltage Vin is supplied to a gate electrode of the transistor QN1. The output voltage Vout is supplied to a gate electrode of the transistor QN2. Source electrodes of the transistors QN1 and QN2 are connected with a drain electrode of the current source transistor CS1. A voltage VEE from a second low-potential-side power supply lower in potential than a voltage VSS from a ground power supply (first low-potential-side power supply) is supplied to a source electrode of the current source transistor CS1. It is preferable that the voltage VEE be set at a potential lower than that of the voltage VSS from the ground power supply in an amount equal to or greater than a threshold voltage Vthn of the transistor QN1 (QN2) making up the differential transistor pair DIF1. A gate voltage VREF1 is supplied to a gate electrode of the current source transistor CS1 to generate the sum of drain currents of the transistors QN1 and QN2 making up the differential transistor pair DIF1.

Drain electrodes of the transistors QN1 and QN2 are respectively connected with drain electrodes of P-type transistors QP1 and QP2 making up the current mirror circuit CM1. Gate electrodes of the transistors QP1 and QP2 are connected. The gate electrode and the drain electrode of the transistor QP2 are also connected. A voltage VDD from a high-potential-side power supply is supplied to source electrodes of the transistors QP1 and QP2.

In the differential amplifier 110 having such a configuration, the voltage of an output node of the differential amplifier 110 changes corresponding to the difference between the input voltage Vin and the output voltage Vout.

The output circuit 120 includes a P-type driver transistor DQP1 and an N-type transistor DQN1 which functions as a load drive current source. The voltage VDD from the high-potential-side power supply is supplied to a source electrode of the driver transistor DQP1, and a drain voltage of the driver transistor DQP1 is the output voltage Vout. A drain voltage of the transistor QP1, which is the output node of the differential amplifier 110, is supplied to a gate electrode of the driver transistor DQP1. A drain electrode of the driver transistor DQPL is connected with a drain electrode of the transistor DQN1. Therefore, the driver transistor DQP1 is provided on the high potential power supply side, is gate-controlled based on the voltage of the output node of the differential amplifier 110, and generates the drain voltage as the output voltage Vout.

The voltage VSS from the ground power supply is supplied to a source electrode of the transistor DQN1. A gate voltage VREF2 is supplied to a gate electrode of the transistor DQN1.

The N-type current source transistor CS1 of the operational amplifier 100 which generates the operating current of the differential amplifier 110 is a transistor in which the potential an impurity layer in which a channel region is formed is set independently of the potential of an impurity layer in which channel regions of other transistors are formed. The current source transistor CS1 may be realized by a transistor having a triple-well structure, a transistor having an epitaxial wafer structure, or a transistor having a silicon-on-insulator (SOI) structure.

In the first configuration example, only the current source transistor CS1 of the operational amplifier 100 has a triple-well structure, and the remaining transistors of the operational amplifier 100 have a twin-well structure. FIG. 5 shows an equivalent circuit when the current source transistor CS1 is realized by a transistor having a triple-well structure.

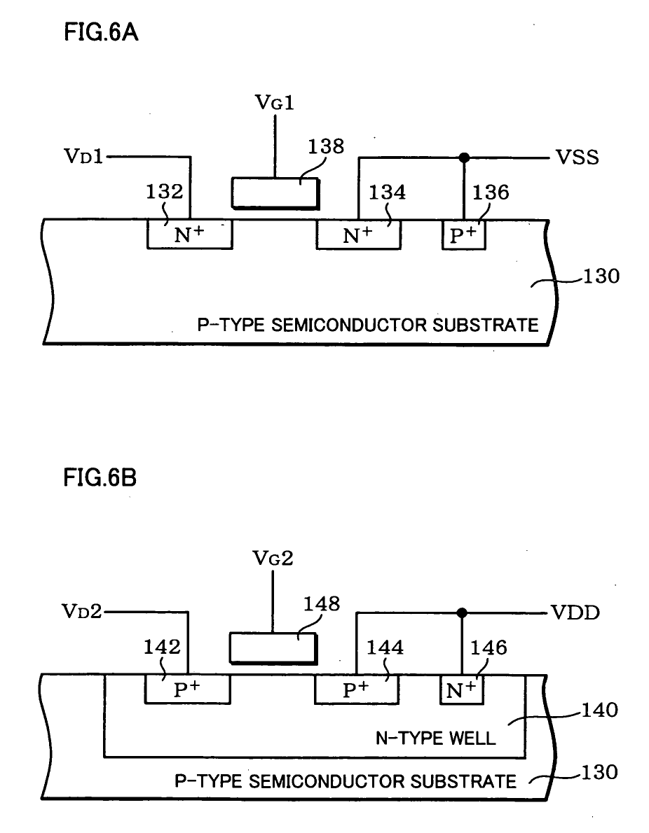

FIGS. 6A and 6B are schematic cross-sectional diagrams of transistors having a twin-well structure. FIG. 6A is a cross-sectional diagram of an N-type transistor, and FIG. 6B is a cross-sectional diagram of a P-type transistor.

In FIG. 6A, high-concentration impurity diffusion layers 132 and 134 containing N-type impurities are formed in a P-type semiconductor substrate 130 as a drain region and a source region, respectively. A high-concentration impurity diffusion layer 136 containing P-type impurities is also formed in the P-type semiconductor substrate 130. A gate electrode 138 is provided over the P-type semiconductor substrate 130 through a gate insulating film in the area between the impurity diffusion layers 132 and 134. A channel region is formed by applying a gate voltage V_{G}1 to the gate electrode 138 in a state in which a drain voltage V_{D}1 is supplied to the impurity diffusion layer 132 and the voltage VSS from the ground power supply is supplied to the impurity diffusion layers 134 and 136.

In FIG. 6B, an N-type well containing N-type impurities (low-concentration impurity layer; hereinafter the same) 140 is formed in the P-type semiconductor substrate 130. High-concentration impurity diffusion layers 142 and 144 containing P-type impurities are formed in the N-type well 140 as a drain region and a source region, respectively A high-concentration impurity diffusion layer 146 containing N-type impurities is also formed in the N-type well 140. A gate electrode 148 is provided over the N-type well 140 through a gate insulating film in the area between the impurity diffusion layers 142 and 144. A channel region is formed by applying a gate voltage V_{G}2 to the gate electrode 148 in a state in which a drain voltage V_{D}2 is supplied to the impurity diffusion layer 142 and the voltage VDD from the high-potential-side power supply is supplied to the impurity diffusion layers 144 and 146.

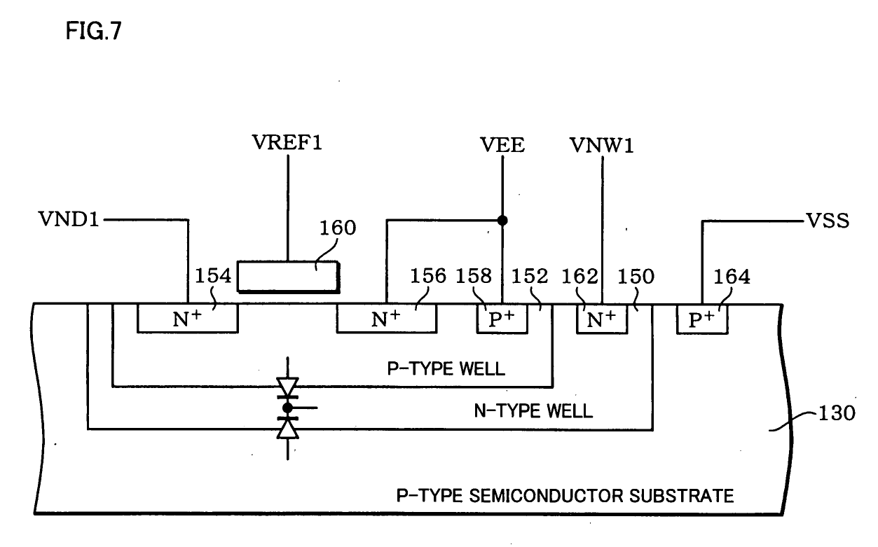

FIG. 7 is a schematic cross-sectional diagram of the current source transistor CS1 shown in FIG. 5. In FIG. 7, the same sections as the sections shown in FIG. 5 or 6A are indicated by the same symbols. Description of these sections is appropriately omitted.

In a triple-well structure, an N-type well 150 containing N-type impurities is formed in the P-type semiconductor substrate 130. A P-type well 152 containing P-type impurities is formed in the N-type well 150. High-concentration impurity diffusion layers 154 and 156 containing N-type impurities are formed in the P-type well 152 as a drain region and a source region, respectively. A high-concentration impurity diffusion layer 158 containing P-type impurities is also formed in the P-type well 152. A gate electrode 160 is provided over the P-type well 152 through a gate insulating film in the area between the impurity diffusion layers 154 and 156. A channel region is formed by applying a gate voltage VREF1 to the gate electrode 160 in a state in which a drain voltage VND1 is supplied to the impurity diffusion layer 154 and the voltage VEE is supplied to the impurity diffusion layers 156 and 158. Specifically, the voltage VEE is supplied to the impurity layer in which the channel region is formed.

A well voltage VNW1 is supplied to the N-type well 150 through a high-concentration impurity diffusion layer 162 containing N-type impurities. The voltage VSS from the ground power supply is supplied to the P-type semiconductor substrate 130 through a high-concentration impurity diffusion layer 164 containing. P-type impurities. It suffices that the well voltage VNW1 be higher than the voltage VSS from the ground power supply and the voltage VEE. For example, the voltage VDD from the high-potential-side power supply may be used as the well voltage VNW1.

In FIG. 5, the current value generated by the current source transistor CS1 can be controlled by setting the gate voltage VREF1 at a constant value and changing the potential of the voltage VEE. In particular, a voltage generation circuit which generates the gate voltage VREF1 while absorbing manufacturing variations or the like can be made unnecessary, and a change in current value due to noise superimposed on the gate voltage VREF1 can be prevented, whereby a more stable current can be generated.

A diode element schematically connected with the substrate of the current source transistor CS1 in FIG. 5 is formed by the P-type well 152, the N-type well 150, and the P-type semiconductor substrate 130 shown in FIG. 6.

In the operational amplifier 100 according to the first configuration example of this embodiment, when the input voltage Vin becomes higher in potential than the output voltage Vout, the impedance between the drain electrode and the source electrode of the transistor QN1 becomes lower than the impedance between the drain electrode and the source electrode of the transistor QN2. Therefore, the potential of the drain electrode of the transistor QN1 decreases, whereby the driver transistor DQP1 becomes turned ON. As a result, the potential of the output voltage Vout increases.

On the other hand, when the input voltage Vin becomes lower in potential than the output voltage Vout, the impedance between the drain electrode and the source electrode of the transistor QN1 becomes higher than the impedance between the drain electrode and the source electrode of the transistor QN2. Therefore, the potential of the drain electrode of the transistor QN1 increases, whereby the driver transistor DQP1 becomes turned OFF. As a result, the potential of the output voltage Vout decreases. As described above, the operational amplifier 100 outputs the output voltage Vout at a potential approximately equal to that of the input voltage Vin.

In the first configuration example, only the current source transistor CS1 has a triple-well structure. This increases the output voltage range of the operational amplifier according to the first configuration example.

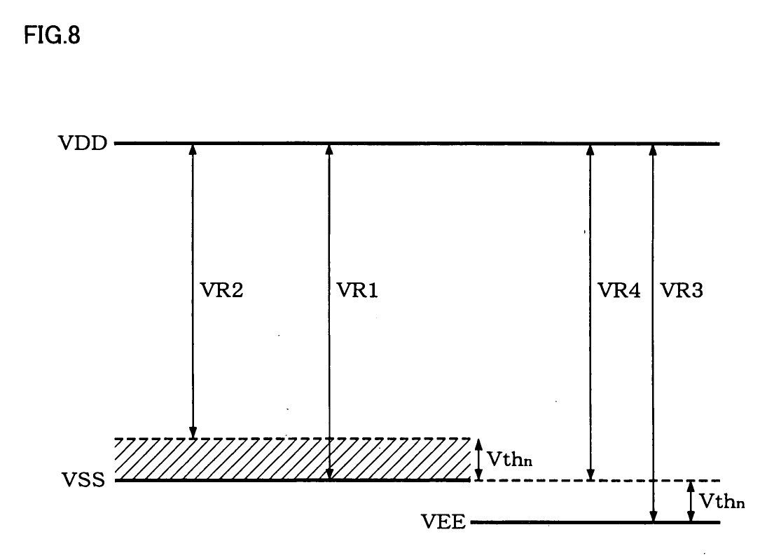

FIG. 8 is a diagram illustrative of the output voltage range of the operational amplifier according to the first configuration example of this embodiment.

Since the operational amplifier applied to the driver circuit is provided in data line units, the operational amplifier is formed using a transistor having a twin-well structure as shown in FIG. 6A or 6B, Which has a small layout area and is inexpensive. A class A operational amplifier formed using such a transistor has an operating power supply voltage range between the voltage VDD from the high-potential-side power supply and the voltage VSS from the first low-potential-side power supply (voltage from the ground power supply). However, when the input voltage Vin supplied to the gate electrode of the N-type transistor making up the differential transistor pair of the differential amplifier is lower than the threshold voltage Vthn of the transistor based on the source voltage of the transistor, the transistor does not operate. Therefore, the range from the voltage VSS to the threshold voltage Vthn becomes an input dead zone. As a result, the operational amplifier operates in a range VR2 although the operating power supply voltage range is VR1.

On the other hand, in the first configuration example, the voltage VEE from the second low-potential-side power supply is supplied to the source electrode of the current source transistor CS1 of the differential amplifier 110. Specifically, a large amount of current can be generated in comparison with the case of using a transistor having a twin well structure by allowing only the current source transistor CS1 to have a triple-well structure. Therefore, even if the input voltage Vin supplied to the gate electrode of the N-type transistor making up the differential transistor pair of the differential amplifier is lower than the threshold voltage Vthn of the transistor based on the source voltage of the transistor, the drain current of the transistor can be generated to allow a transistor operation. As a result, the potential of the input dead zone of the transistors QN1 and QN2 of the differential amplifier 110 can be decreased, whereby the operation power supply voltage range can be set in a range VR3 between the voltage VDD from the high-potential-side power supply and the voltage VEE from the second low-potential-side power supply, and the output voltage range can be set in a range VR4 between the voltage VDD from the high-potential-side power supply and the voltage VSS from the first low-potential-side power supply (voltage from the ground power supply).

Since only the current source transistor CS1 and the transistor DQN1 operate as the current sources, an increase in the number of current paths can be prevented in comparison with the case of providing an additional circuit, whereby an increase in current consumption can be prevented.

As described above, according to the first configuration example, the output voltage range can be increased at a low power consumption while preventing an increase in the circuit scale by allowing only the current source transistor CS1 to have a triple-well structure.

Although the first configuration example illustrates the case where only the current source transistor CS1 has a triple-well structure, all the transistors shown in FIG. 5 may have a triple-well structure. In this case, the layout area is increased. However, since the characteristics of the transistors can be easily made uniform, the characteristics of the operational amplifier can be easily adjusted.

2.1.1 Modification of First Configuration Example

The first configuration example illustrates the case where the operational amplifier is formed on the P-type semiconductor substrate. However, this embodiment is not limited thereto. In a modification of the first configuration example, an operational amplifier is formed on an N-type semiconductor substrate.

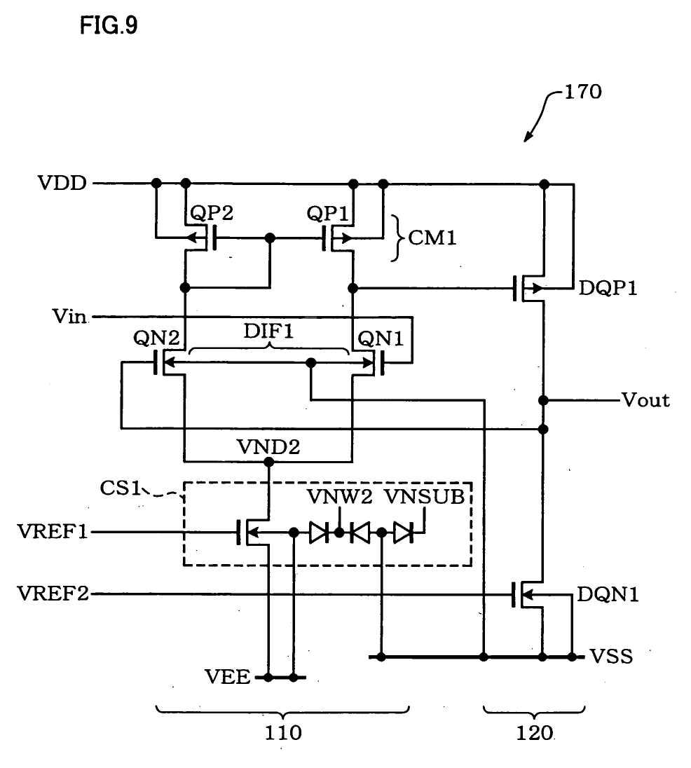

FIG. 9 is a circuit diagram of an operational amplifier according to the modification of the first configuration example. In FIG. 9, the same sections as the sections shown in FIG. 5 are indicated by the same symbols. Description of these sections is appropriately omitted.

The equivalent circuit of the current source transistor CS1 differs between an operational amplifier 170 shown in FIG. 9 and the operational amplifier 100 shown in FIG. 5 due to the difference in the conductivity type of the substrate.

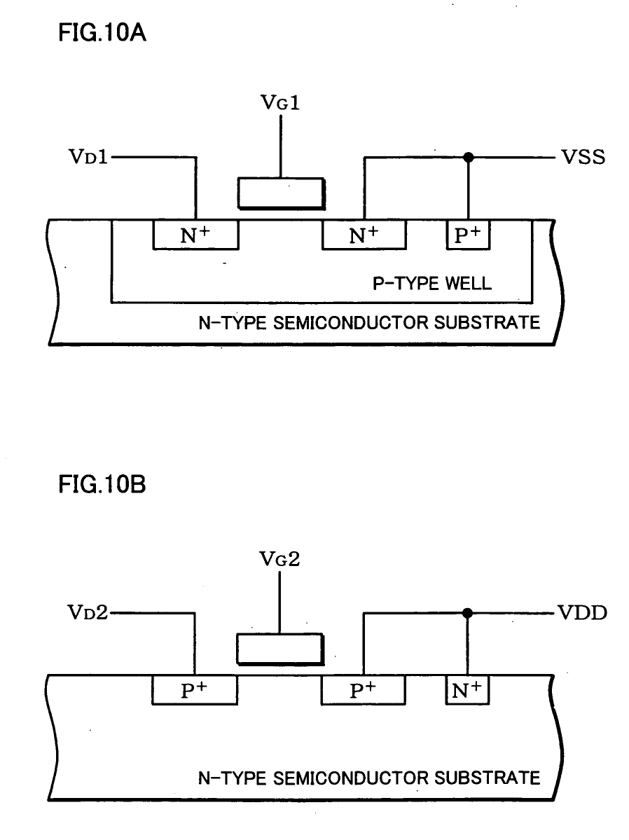

FIGS. 10A and 10B are schematic cross-sectional diagrams of transistors having a twin-well structure. FIG. 10A is a cross-sectional diagram of an N-type transistor, and FIG. 10B is a cross-sectional diagram of a P-type transistor. In FIGS. 10A and 10B and FIGS. 6A and 6B, the conductivity type of the semiconductor substrate differs and the configuration is changed due to the difference in the conductivity type of the semiconductor substrate. Since the configuration of the transistor having a twin-well structure is known, the description thereof is omitted.

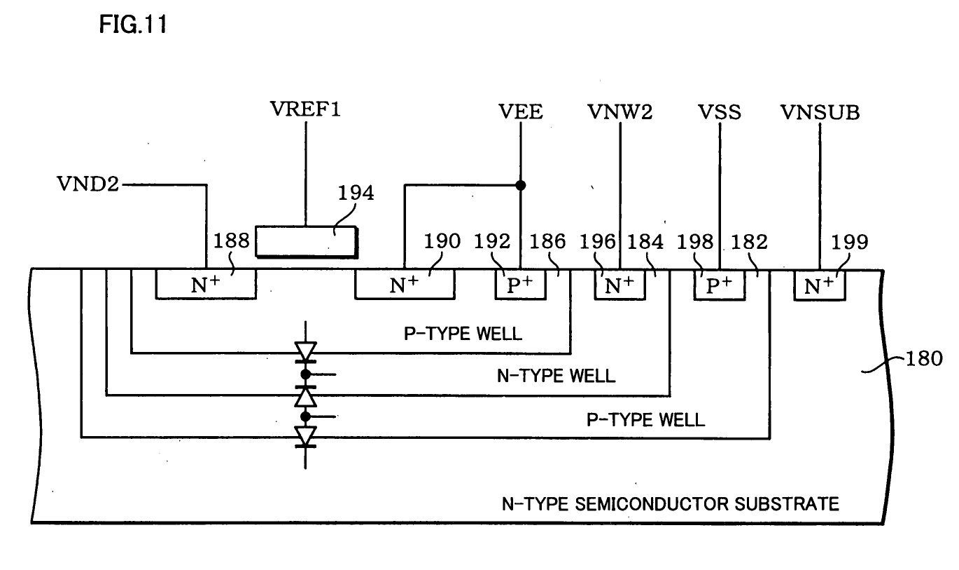

FIG. 11 is a schematic cross-sectional diagram of the current source transistor CS1 shown in FIG. 9. In FIG. 11, the same sections as the sections shown in FIG. 9 are indicated by the same symbols. Description of these sections is appropriately omitted.

In FIG. 11, a P-type well 182 containing P-type impurities is formed in an N-type semiconductor substrate 180. An N-type well 184 containing N-type impurities is formed in the P-type well 182. A P-type well 186 containing P-type impurities is formed in the N-type well 182.

High-concentration impurity diffusion layers 188 and 190 containing N-type impurities are formed in the P-type well 186 as a drain region and a source region, respectively. A high-concentration impurity diffusion layer 192 containing P-type impurities is also formed in the P-type well 186. A gate electrode 194 is provided over the P-type well 186 through a gate insulating film in the area between the impurity diffusion layers 188 and 190. A channel region is formed by applying the gate voltage VREF1 to the gate electrode 194 in a state in which a drain voltage VND2 is supplied to the impurity diffusion layer 188 and the voltage VEE is supplied to the impurity diffusion layers 190 and 192.

A well voltage VNW2 is supplied to the N-type well 184 through a high-concentration impurity diffusion layer 196 containing N-type impurities. The voltage VSS from the ground power supply is supplied to the P-type well 182 through a high-concentration impurity diffusion layer 198 containing P-type impurities. A substrate voltage VNSUB is supplied to the N-type semiconductor substrate 180 through a high-concentration impurity diffusion layer 199 containing N-type impurities. It suffices that the well voltage VNW2 be higher than the voltage VSS from the ground power supply and the voltage VEE. For example, the voltage VDD from the high-potential-side power supply may be used as the well voltage VNW2. It suffices that the substrate voltage VNSUB be higher in potential than the voltage VSS from the ground power supply. For example, the voltage VDD from the high-potential-side power supply may be used as the substrate voltage VNSUB.

A diode element schematically connected with the substrate of the current source transistor CS1 in FIG. 5 is formed by the P-type well 186, the N-type well 184, the P-type well 182, and the N-type semiconductor substrate 180 shown in FIG. 11.

As described above, according to the modification of the first configuration example, the output voltage range can be increased at a low power consumption while preventing an increase in the circuit scale by allowing only the current source transistor CS1 to have a triple-well structure in the same manner as in the first configuration example.

Although the modification of the first configuration example illustrates the case where only the current source transistor CS1 has a triple-well structure, all the transistors shown in FIG. 9 may have a triple-well structure. In this case, the layout area is increased. However, since the characteristics of the transistors can be easily made uniform, the characteristics of the operational amplifier can be easily adjusted.

2.2 Second Configuration Example

The first configuration example illustrates the case of applying this embodiment to the class A operational amplifier. Note that this embodiment is not limited to the class A operational amplifier. A second configuration example illustrates the case of applying this embodiment to a class AB operational amplifier.

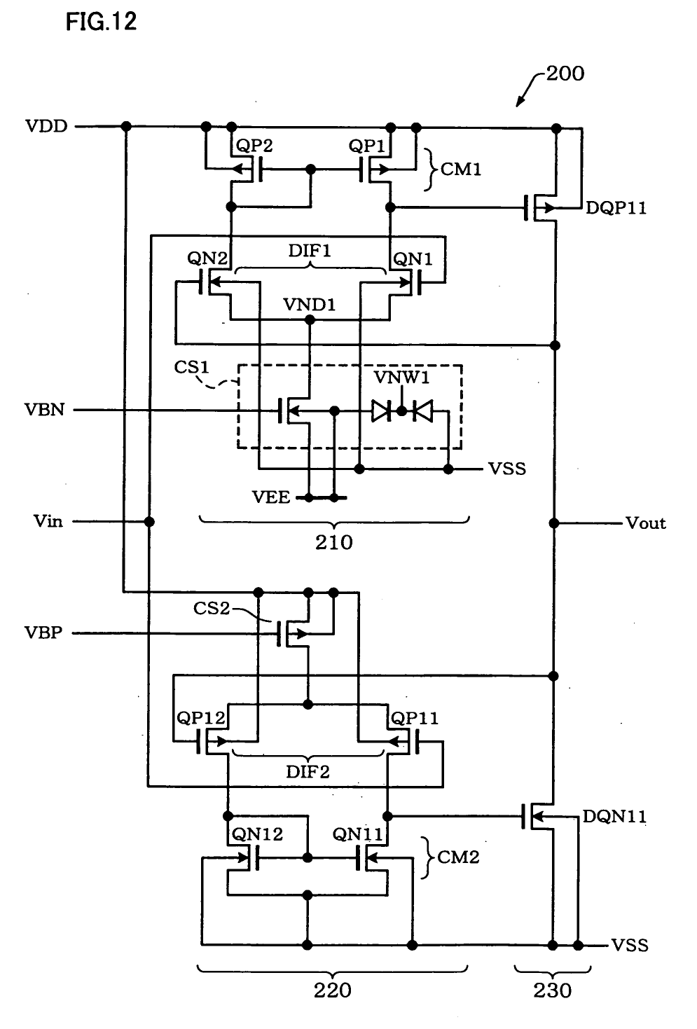

FIG. 12 is a circuit diagram of an operational amplifier according to the second configuration example of this embodiment. In FIG. 12, the same sections as the sections shown in FIG. 5 are indicated by the same symbols. Description of these sections is appropriately omitted.

An operational amplifier 200 shown in FIG. 12 is applied as one of the operational amplifiers OPC₁ to OPC_{N} shown in FIG. 3. In this case, the input voltage Vin is the data voltage generated by the DAC 528, and the output voltage Vout is the drive voltage supplied to the data line.

The operational amplifier 200 includes an N-type differential amplifier 210 (first differential amplifier), a P-type differential amplifier 220 (second differential amplifier), and an output circuit 230. The N-type differential amplifier 210, the P-type differential amplifier 220, and the output circuit 230 are formed on a P-type semiconductor substrate. The operational amplifier 200 is a class AB operational amplifier.

In more detail, the N-type differential amplifier 210 has the same configuration as that of the differential amplifier 110 shown in FIG. 5. Specifically, the N-type differential amplifier 210 (first differential amplifier) includes the N-type differential transistor pair DIF1 (first differential transistor pair) to which the input voltage Vin and the output voltage Vout are supplied at respective gates, and the N-type current source transistor CS1 (first current source transistor) which generates the sum of the drain currents of the transistors QN1 and QN2 making up the differential transistor pair DIF1, and amplifies the difference between the input voltage Vin and the output voltage Vout.

The P-type differential amplifier 220 includes a P-type differential transistor pair DIF2 (second differential transistor pair), a current mirror circuit CM2, and a current source transistor CS2 (second current source transistor). The differential transistor pair includes P-type transistors QP11 and QP12. The input voltage Vin is supplied to a gate electrode of the transistor QP11. The output voltage Vout is supplied to a gate electrode of the transistor QP12. Source electrodes of the transistors QP11 and QP12 are connected with a drain electrode of the current source transistor CS2. The voltage VDD from a high-potential-side power supply is supplied to a source electrode of the current source transistor CS2. A gate voltage VBN is supplied to a gate electrode of the current source transistor CS2 to generate the sum of drain currents of the transistors QP11 and QP12 making up the differential transistor pair DIF2.

Drain electrodes of the transistors QP11 and QP12 are respectively connected with drain electrodes of N-type transistors QN11 and QN12 making up the current mirror circuit CM2. Gate electrodes of the transistors QN11 and QN12 are connected. The gate electrode and the drain electrode of the transistor QN12 are also connected. The voltage VSS from the ground power supply is supplied to source electrodes of the transistors QN11 and QN12.

Specifically, the P-type differential amplifier 220 (second differential amplifier) includes the P-type differential transistor pair DIF2 (second differential transistor pair) to which the input voltage Vin and the output voltage Vout are supplied at respective gates, and the P-type current source transistor CS2 (second current source transistor) which generates the sum of the drain currents of the transistors QP11 and QP12 making up the differential transistor pair DIF2, and amplifies the difference between the input voltage Vin and the output voltage Vout.

In the P-type differential amplifier 220 having such a configuration, the voltage of an output node of the differential amplifier 220 changes corresponding to the difference between the input voltage Vin and the output voltage Vout in the same manner as in the N-type differential amplifier 210.

The output circuit 230 includes a P-type driver transistor DQP11 and an N-type driver transistor DQN11. The voltage VDD from the high-potential-side power supply is supplied to a source electrode of the driver transistor DQP11, and a drain voltage of the driver transistor DQP11 is the output voltage Vout. A drain voltage of the transistor QP11, which is the output node of the differential amplifier 210, is supplied to a gate electrode of the driver transistor DQP11.

The voltage VSS from the ground power supply is supplied to a source electrode of the driver transistor DQN11, and a drain voltage of the driver transistor DQN11 is the output voltage Vout. A drain voltage of the transistor QP11, which is the output node of the P-type differential amplifier 220, is supplied to a gate electrode of the driver transistor DQN11. A drain electrode of the driver transistor DQP1 is connected with a drain electrode of the transistor DQN11.

Specifically, the driver transistor DQP11 is provided on the high potential power supply side, is gate-controlled based on the voltage of the output node of the differential amplifier 210, and generates the drain voltage as the output voltage. The driver transistor DQN11 is provided on the low potential power supply side, is gate-controlled based on the voltage of the output node of the differential amplifier 220, and generates the drain voltage as the output voltage.

The N-type current source transistor CS1 of the operational amplifier 200 shown in FIG. 12 which generates the operating current of the differential amplifier 210 is a transistor in which the potential of an impurity layer in which a channel region is formed is set independently of the potential of an impurity layer in which channel regions of other transistors are formed. The current source transistor CS1 may be realized by a transistor having a triple-well structure, a transistor having an epitaxial wafer structure, or a transistor having an SOI structure.

In the second configuration example, only the current source transistor CS1 of the operational amplifier 210 making up the operational amplifier 200 has a triple-well structure, and the remaining transistors of the operational amplifier 200 have a twin-well structure. FIG. 12 shows an equivalent circuit when the current source transistor CS1 is realized by a transistor having a triple-well structure.

The operation of the operational amplifier 200 according to the second configuration example is described below. In the N-type operational amplifier 210, when the input voltage Vin becomes higher in potential than the output voltage Vout, the impedance between the drain electrode and the source electrode of the transistor QN1 becomes lower than the impedance between the drain electrode and the source electrode of the transistor QN2. Therefore, the potential of the drain electrode of the transistor QN1 decreases, whereby the driver transistor DQP11 becomes turned ON.

In the P-type operational amplifier 220, when the input voltage Vin becomes higher in potential than the output voltage Vout, the impedance between the drain electrode and the source electrode of the transistor QP11 becomes higher than the impedance between the drain electrode and the source electrode of the transistor QP12. Therefore, the potential of the drain electrode of the transistor QP11 decreases, whereby the driver transistor DQN11 becomes turned OFF.

Therefore, the potential of the output voltage Vout increases in the operational amplifier 200 when the input voltage Vin becomes higher in potential than the output voltage Vout.

On the other hand, in the N-type operational amplifier 210, when the input voltage Vin becomes lower in potential than the output voltage Vout, the impedance between the drain electrode and the source electrode of the transistor QN1 becomes higher than the impedance between the drain electrode and the source electrode of the transistor QN2. Therefore, the potential of the drain electrode of the transistor QN1 increases, whereby the driver transistor DQP11 becomes turned OFF.

In the P-type operational amplifier 220, when the input voltage Vin becomes lower than the output voltage Vout, the impedance between the drain electrode and the source electrode of the transistor QP11 becomes lower than the impedance between the drain electrode and the source electrode of the transistor QP12. Therefore, the potential of the drain electrode of the transistor QP11 increases, whereby the driver transistor DQN11 becomes turned ON.

Therefore, the potential of the output voltage Vout decreases in the operational amplifier 200 when the input voltage Vin becomes lower in potential than the output voltage Vout.

In the second configuration example, only the current source transistor CS1 of the N-type differential amplifier 210 has a triple-well structure. This increases the output voltage range of the operational amplifier according to the second configuration example.

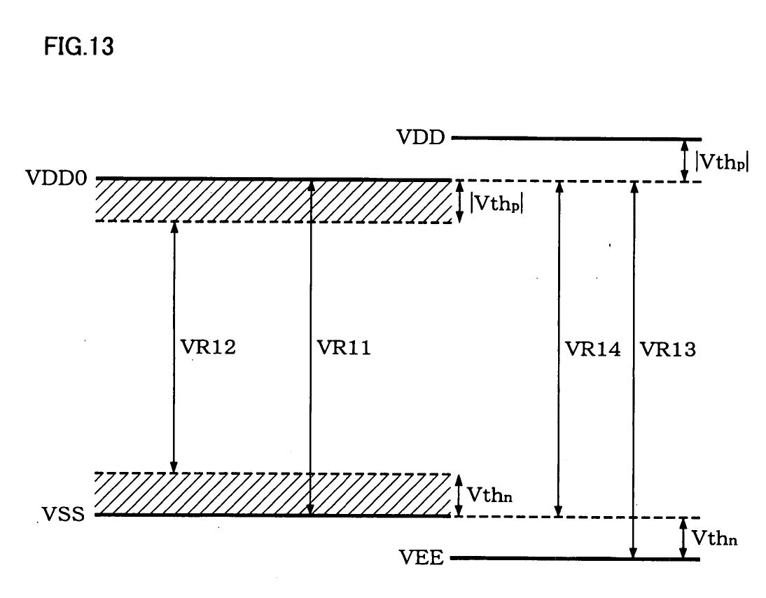

FIG. 13 is a diagram illustrative of the output voltage range of the operational amplifier according to the second configuration example of this embodiment.

A class AB operational amplifier has an operating power supply voltage range between a voltage VDD0 from the high-potential-side power supply and the voltage VSS from the first low-potential-side power supply (voltage from the ground power supply). However, when the input voltage Vin supplied to the gate electrode of the N-type transistor making up the differential transistor pair of the N-type differential amplifier is lower than the threshold voltage Vthn of the transistor based on the source voltage of the transistor, the transistor does not operate. Therefore, the range from the voltage VSS to the threshold voltage Vthn becomes an input dead zone. The threshold voltage of the P-type transistor making up the differential transistor pair of the P-type differential amplifier is indicated by Vthp. When the input voltage Vin supplied to the gate electrode of the transistor is higher than (VDD0-|Vthp|) based on the voltage VSS from the ground power supply, the transistor does not operate. Therefore, the range from the voltage VDD to (VDD-|Vthp|) becomes an input dead zone. As a result, the operational amplifier operates in a range VR12 although the operating power supply voltage range is VR11.

In the second configuration example, only the current source transistor CS1 of the N-type differential amplifier 210 of the N-type differential amplifier 210 and the P-type differential amplifier 220 has a triple-well structure, and the voltage VEE is supplied to the source electrode of the current source transistor CS1. The current source transistor CS2 of the P-type differential amplifier 220 has a twin-well structure, and the voltage VDD higher in potential than the voltage VDD0 from the high-potential-side power supply is supplied to the source electrode of the current source transistor CS2. This is because, while it is necessary to allow the N-type transistor to have a triple-well structure in order to supply a voltage lower in potential than the voltage VSS from the ground power supply, it suffices that the P-type transistor have a twin-well structure if the voltage VDD is in the breakdown voltage range of the P-type transistor.

As a result, even if the input voltage Vin supplied to the gate electrode of the N-type transistor making up the differential transistor pair of the N-type differential amplifier is lower than the threshold voltage Vthn of the transistor based on the source voltage of the transistor, the drain current of the transistor can be generated to allow a transistor operation. Therefore, the potential of the input dead zone of the transistors QN1 and QN2 of the N-type differential amplifier 210 can be decreased. Moreover, even if the input voltage Vin supplied to the P-type transistor making up the differential transistor pair of the P-type differential amplifier 220 is higher than (VDD-|Vthp|) based on the voltage VSS from the ground power supply, the drain current of the transistor can be generated to allow a transistor operation. Therefore, the potential of the input dead zone of the transistors QP11 and QP12 of the P-type differential amplifier 220 can be increased.

As described above, in the operational amplifier 200, the operation power supply voltage range can be set in a range VR13 between the voltage VDD from the high-potential-side power supply and the voltage VEE from the second low-potential-side power supply, and the output voltage range can be set in a range VR14 between the voltage VDD0 from the high-potential-side power supply and the voltage VSS from the first low-potential-side power supply (voltage from the ground power supply).

According to the second configuration example, the output voltage range can be increased at a low power consumption while preventing an increase in the circuit scale by allowing only the current source transistor CS1 to have a triple-well structure.

2.2.1 First modification of Second Configuration Example

The second configuration example illustrates the case where only the current source transistor CS1 of the N-type differential amplifier 210 of the N-type differential amplifier 210 and the P-type differential amplifier 220 has a triple-well structure. However, this embodiment is not limited thereto.

In the class AB operational amplifier, since the output voltage Vout changes corresponding to the current drive capabilities of the driver transistors DQP11 and DQN11, it is desirable that the rising edge and the falling edge of the output voltage Vout be made uniform. If the operating currents of the differential amplifiers 210 and 220 which control the current drive capabilities of the driver transistors DQP11 and DQN11 are the same, the current drive capabilities of the driver transistors DQP11 and DQN11 can be easily adjusted. Therefore, it is desirable that the current source transistor CS2 of the P-type differential amplifier 220 also have a triple-well structure. This makes it possible to easily make uniform the current values generated by the current source transistors.

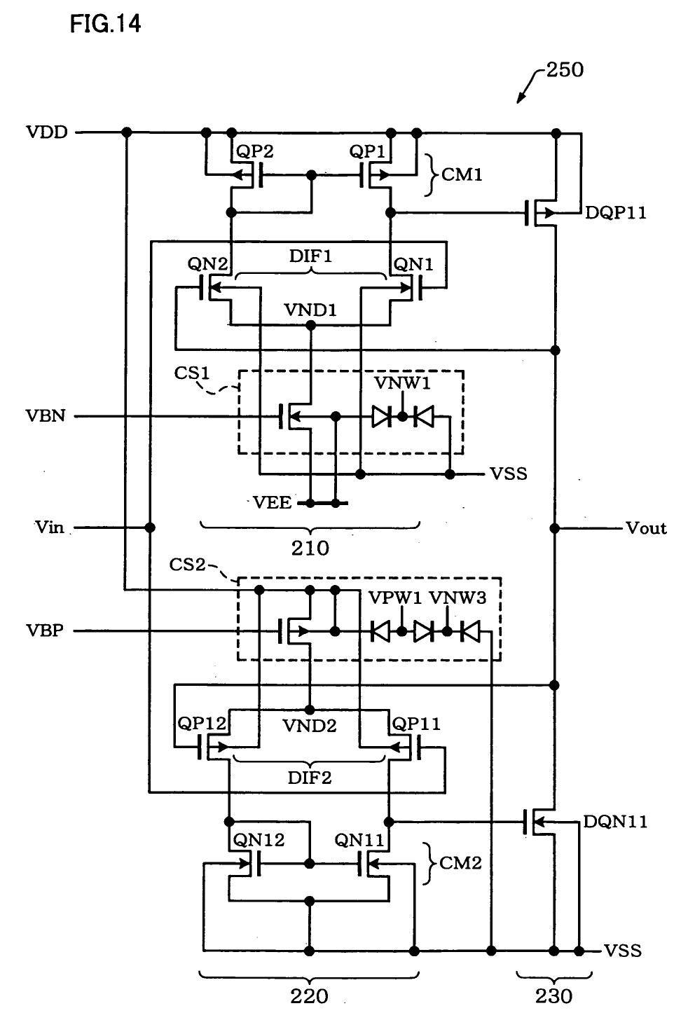

FIG. 14 is a circuit diagram of an operational amplifier according to a first modification of the second configuration example. In FIG. 14, the same sections as the sections shown in FIG. 12 are indicated by the same symbols. Description of these sections is appropriately omitted.

An operational amplifier 250 shown in FIG. 14 differs from the operational amplifier 200 shown in FIG. 12 in that the current source transistor CS2 of the P-type differential amplifier 220 has a triple-well structure. FIG. 14 shows an equivalent circuit when the current source transistor CS2 is realized by a transistor having a triple-well structure.

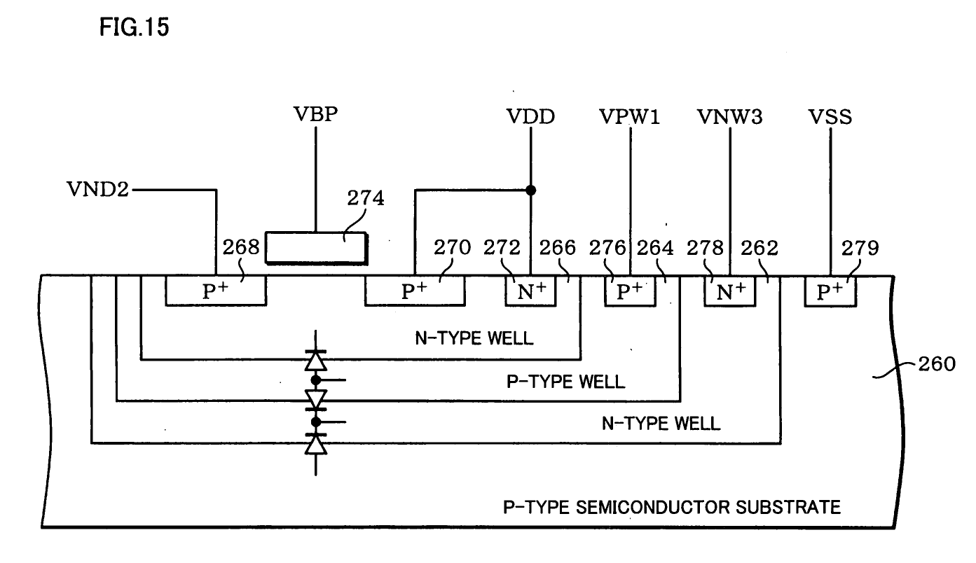

FIG. 15 is a schematic cross-sectional diagram of the current source transistor CS2 shown in FIG. 14. In FIG. 15, the same sections as the sections shown in FIG. 14 are indicated by the same symbols. Description of these sections is appropriately omitted.

In FIG. 15, an N-type well 262 containing N-type impurities is formed in a P-type semiconductor substrate 260. A P-type well 264 containing P-type impurities is formed in the N-type well 262. An N-type well 266 containing N-type impurities is formed in the P-type well 264.

High-concentration impurity diffusion layers 268 and 270 containing P-type impurities are formed in the N-type well 266 as a drain region and a source region, respectively. A high-concentration impurity diffusion layer 272 containing N-type impurities is also formed in the N-type well 266. A gate electrode 274 is provided over the N-type well 266 through a gate insulating film in the area between the impurity diffusion layers 268 and 270. A channel region is formed by applying a gate voltage VBP to the gate electrode 274 in a state in which the drain voltage VND2 is supplied to the impurity diffusion layer 268 and the voltage VDD is supplied to the impurity diffusion layers 270 and 272.

A well voltage VPW1 is supplied to the P-type well 184 through a high-concentration impurity diffusion layer 276 containing P-type impurities. A well voltage VNW3 is supplied to the N-type well 262 through a high-concentration impurity diffusion layer 278 containing N-type impurities. The voltage VSS from the ground power supply is supplied to the P-type semiconductor substrate 260 through a high-concentration impurity diffusion layer 279 containing P-type impurities. It suffices that the well voltage VPW1 be lower in potential than the voltage VDD and that the well voltage VNW3 be higher in potential than the voltage VSS from the ground power supply and the well voltage VPW1.

A diode element schematically connected with the substrate of the current source transistor CS2 in FIG. 14 is formed by the N-type well 266, the P-type well 264, the N-type well 262, and the P-type semiconductor substrate 260 shown in FIG. 15.

Although the first modification of the second configuration example illustrates the case where only the current source transistors CS1 and cs2 HAVE a triple-well structure, all the transistors shown in FIG. 14 may have a triple-well structure. In this case, the layout area is increased. However, since the characteristics of the transistors can be easily made uniform, the characteristics of the operational amplifier can be easily adjusted.

2.2.2 Second Modification of Second Configuration Example

The first modification of the second configuration example illustrates the case where the operational amplifier is formed on the P-type semiconductor substrate. However, this embodiment is not limited thereto. In a second modification of the second configuration example, an operational amplifier is formed on an N-type semiconductor substrate.

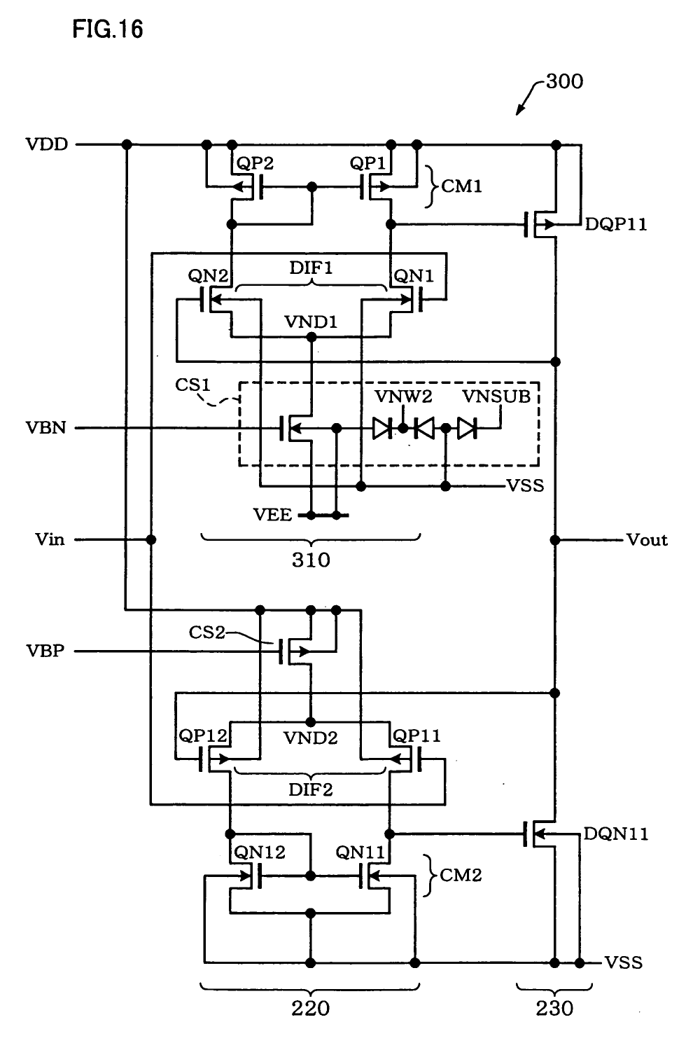

FIG. 16 is a circuit diagram of an operational amplifier according to the second modification of the second configuration example. In FIG. 16, the same sections as the sections shown in FIG. 9 or 12 are indicated by the same symbols. Description of these sections is appropriately omitted.

The equivalent circuit of the current source transistor CS1 differs between an operational amplifier 300 shown in FIG. 16 and the operational amplifier 200 shown in FIG. 12 due to the difference in the conductivity type of the substrate. An N-type differential amplifier 310 of the operational amplifier 300 has the same configuration as that of the N-type differential amplifier 110 shown in FIG. 9.

According to the second modification of the second configuration example, the output voltage range can be increased at a low power consumption while preventing an increase in the circuit scale by allowing only the current source transistor CS1 to have a triple-well structure in the same manner as in the second configuration example shown in FIG. 12.

2.2.3 Third Modification of Second Configuration Example

The second modification of the second configuration example illustrates the case where the operational amplifier is formed on the P-type semiconductor substrate. However, this embodiment is not limited thereto. In a third modification of the second configuration example, an operational amplifier is formed on an N-type semiconductor substrate.

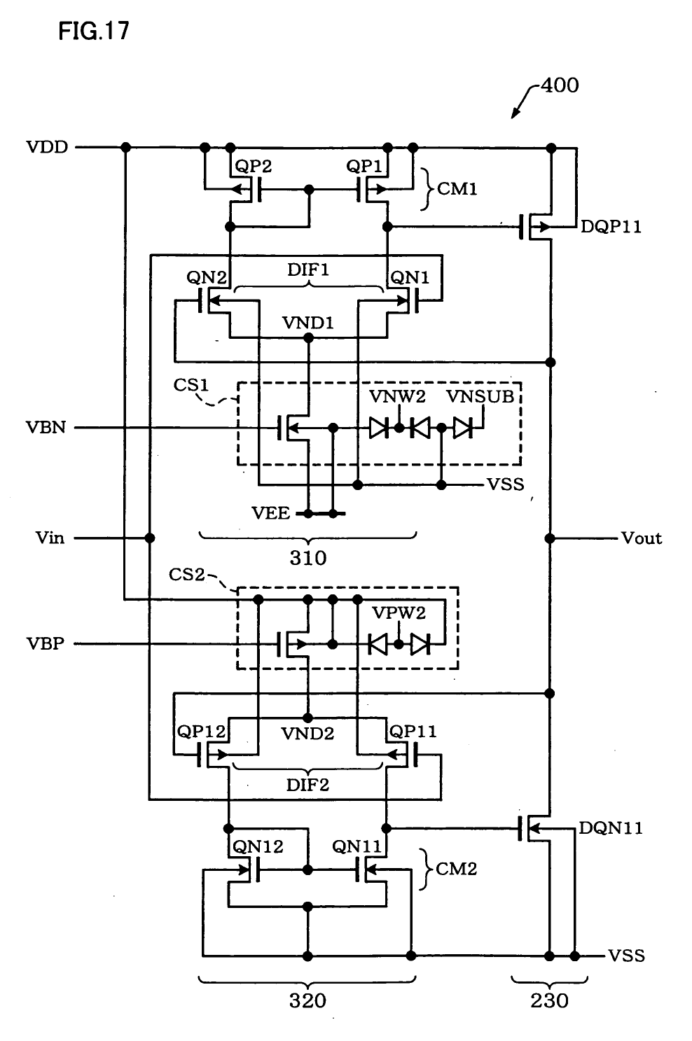

FIG. 17 is a circuit diagram of an operational amplifier according to the third modification of the second configuration example. In FIG. 17, the same sections as the sections shown in FIG. 16 are indicated by the same symbols. Description of these sections is appropriately omitted.

The equivalent circuit of the current source transistor CS2 differs between an operational amplifier 400 shown in FIG. 17 and the operational amplifier 300 shown in FIG. 16 due to the difference in the conductivity type of the substrate.

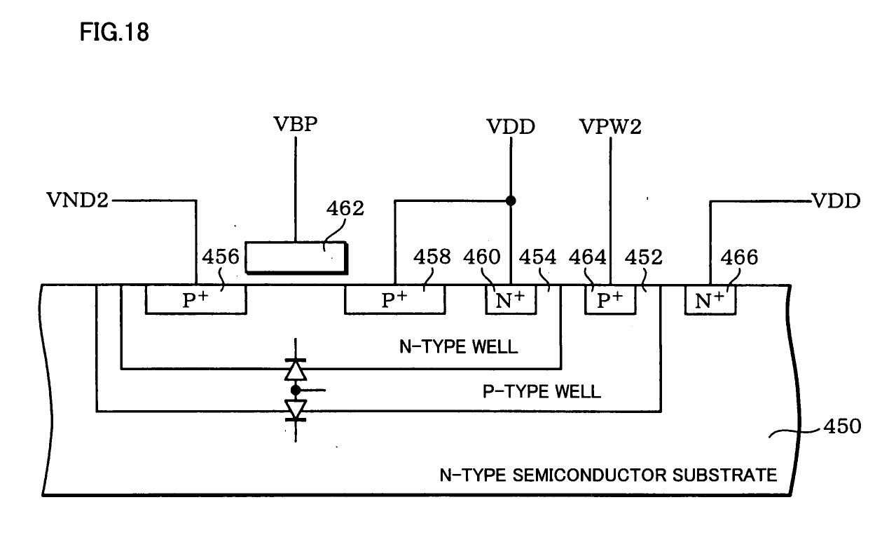

FIG. 18 is a schematic cross-sectional diagram of the current source transistor CS2 shown in FIG. 17. In FIG. 18, the same sections as the sections shown in FIG. 17 are indicated by the same symbols. Description of these sections is appropriately omitted.

In FIG. 18, a P-type well 452 containing P-type impurities is formed in an N-type semiconductor substrate 450. An N-type well 454 containing N-type impurities is formed in the P-type well 452. High-concentration impurity diffusion layers 456 and 458 containing P-type impurities are formed in the N-type well 454 as a drain region and a source region, respectively. A high-concentration impurity diffusion layer 460 containing N-type impurities is also formed in the N-type well 454. A gate electrode 462 is provided over the N-type well 454 through a gate insulating film in the area between the impurity diffusion layers 456 and 458. A channel region is formed by applying the gate voltage VBP to the gate electrode 462 in a state in which the drain voltage VND2 is supplied to the impurity diffusion layer 456 and the voltage VDD is supplied to the impurity diffusion layers 458 and 460.

A well voltage VPW2 is supplied to the P-type well 452 through a high-concentration impurity diffusion layer 464 containing P-type impurities. The voltage VDD is supplied to the N-type semiconductor substrate 450 through a high-concentration impurity diffusion layer 466 containing N-type impurities. It suffices that the well voltage VPW2 be lower in potential than the voltage VDD. For example, the voltage VSS from the ground power supply may be used as the well voltage VPW2.

A diode element schematically connected with the substrate of the current source transistor CS2 in FIG. 17 is formed by the N-type well 454, the P-type well 452, and the N-type semiconductor substrate 450 shown in FIG. 18.

According to the third modification of the second configuration example, the current values generated by the current source transistors CS1 and CS2 can be easily made uniform by allowing the current source transistors CS1 and CS2 to have a triple-well structure in the same manner as in the second modification of the second configuration example shown in FIG. 16.

In the above-described embodiment, configuration example, or modification, the transistor having a triple-well structure may be replaced with a transistor having an epitaxial wafer structure or a transistor having an SOI structure.

In the above-described embodiment, configuration example, or modification, when forming the current source using a transistor having a triple-well structure, a change in the current value due to noise superimposed on the gate voltage can be prevented by controlling the well voltage while setting the gate voltage at a constant value, whereby a more stable current can be generated.

The invention is not limited to the above-described embodiments. Various modifications and variations may be made within the spirit and scope of the invention. For example, the invention may be applied not only to drive the above-described liquid crystal display panel, but also to drive an electroluminescent or plasma display device.

The invention according to the dependent claim may have a configuration in which some of the constituent elements of the claim on which the invention is dependent are omitted. It is possible to allow a feature of the invention according to one independent claim to depend on another independent claim.

Although only some embodiments of the invention are described in detail above, those skilled in the art would readily appreciate that many modifications are possible in the embodiments without materially departing from the novel teachings and advantages of the invention. Accordingly, such modifications are intended to be included within the scope of the invention.

What is claimed is:

1. An operational amplifier comprising:
a differential amplifier which includes an N-type differential transistor pair to which an input voltage and an output voltage are supplied at respective gates, and an N-type current source transistor which generates the sum of drain currents of the transistors making up the differential transistor pair, and amplifies a difference between the input voltage and the output voltage; and
a P-type driver transistor which is provided on a high potential power supply side, is gate-controlled based on voltage of an output node of the differential amplifier, and generates a drain voltage as the output voltage;
the current source transistor being a transistor in which a potential of an impurity layer in which a channel region is formed is set independently of a potential of an impurity layer in which channel regions of other transistors are formed.

2. The operational amplifier as defined in claim 1, wherein the impurity layer in which the channel region of the current source transistor is formed is set at a potential lower than a potential of a ground power supply.

3. The operational amplifier as defined in claim 2, wherein the impurity layer in which the channel region of the current source transistor is formed is set at a potential lower than the potential of the ground power supply in an amount equal to or greater than a threshold voltage of the transistor making up the differential transistor pair.

4. An operational amplifier comprising:
a first differential amplifier which includes an N-type first differential transistor pair to which an input voltage and an output voltage are supplied at respective gates, and an N-type first current source transistor which generates the sum of drain currents of the transistors making up the differential transistor pair, and amplifies a difference between the input voltage and the output voltage;
a second differential amplifier which includes a P-type second differential transistor pair to which the input voltage and the output voltage are supplied at respective gates, and a P-type second current source transistor which generates the sum of drain currents of the transistors making up the second differential transistor pair, and amplifies a difference between the input voltage and the output voltage;
a P-type first driver transistor which is provided on a high potential power supply side, is gate-controlled based on voltage of an output node of the first differential amplifier, and generates a drain voltage as the output voltage; and
an N-type second driver transistor which is provided on a low potential power supply side, is gate-controlled based on voltage of an output node of the second differential amplifier, and generates a drain voltage as the output voltage;
the first current source transistor of the first current source transistor and the second current source transistor being a transistor in which a potential of an impurity layer in which a channel region is formed is set independently of a potential of an impurity layer in which channel regions of other transistors are formed.

5. The operational amplifier as defined in claim 4, wherein the impurity layer in which the channel region of the first current source transistor is formed is set at a potential lower than a potential of a ground power supply.

6. The operational amplifier as defined in claim 5, wherein the impurity layer in which the channel region of the first current source transistor is formed is set at a potential lower than the potential of the ground power supply in an amount equal to or greater than a threshold voltage of the transistor making up the first differential transistor pair.

7. The operational amplifier as defined in claim 4, wherein the second current source transistor is a transistor in which a potential of an impurity layer in which a channel region is formed is set independently of a potential of an impurity layer in which channel regions of other transistors are formed.

8. The operational amplifier as defined in claim 5, wherein the second current source transistor is a transistor in which a potential of an impurity layer in which a channel region is formed is set independently of a potential of an impurity layer in which channel regions of other transistors are formed.

9. The operational amplifier as defined in claim 6, wherein the second current source transistor is a transistor in which a potential of an impurity layer in which a channel region is formed is set independently of a potential of an impurity layer in which channel regions of other transistors are formed.

10. The operational amplifier as defined in claim 1, wherein the transistor in which a potential of an impurity layer in which a channel region is formed is set independently of a potential of an impurity layer in which channel regions of other transistors are formed is a transistor having a triple-well structure.

11. The operational amplifier as defined in claim 4, wherein the transistor in which a potential of an impurity layer in which a channel region is formed is set independently of a potential of an impurity layer in which channel regions of other transistors are formed is a transistor having a triple-well structure.

12. The operational amplifier as defined in claim 1, wherein the transistor in which a potential of an impurity layer in which a channel region is formed is set independently of a potential of an impurity layer in which channel regions of other transistors are formed is a transistor having an epitaxial wafer structure.

13. The operational amplifier as defined in claim 4, wherein the transistor in which a potential of an impurity layer in which a channel region is formed is set independently of a potential of an impurity layer in which channel regions of other transistors are formed is a transistor having an epitaxial wafer structure.

14. The operational amplifier as defined in claim 1, wherein the transistor in which a potential of an impurity layer in which a channel region is formed is set independently of a potential of an impurity layer in which channel regions of other transistors are formed is a transistor having a silicon-on-insulator (SOI) structure.

15. The operational amplifier as defined in claim 4, wherein the transistor in which a potential of an impurity layer in which a channel region is formed is set independently of a potential of an impurity layer in which channel regions of other transistors are formed is a transistor having a silicon-on-insulator (SOI) structure.

16. A driver circuit for driving an electro-optical device including a plurality of scan lines, a plurality of data lines, and pixel electrodes specified by the scan lines and the data lines, the driver circuit comprising:
a data voltage generation circuit which generates a data voltage in units of the data lines; and
the operational amplifier as defined in claim 1 which is provided in units of the data lines and drives the data line based on the data voltage generated by the data voltage generation circuit.

17. A driver circuit for driving an electro-optical device including a plurality of scan lines, a plurality of data lines, and pixel electrodes specified by the scan lines and the data lines, the driver circuit comprising:
a data voltage generation circuit which generates a data voltage in units of the data lines; and
the operational amplifier as defined in claim 4 which is provided in units of the data lines and drives the data line based on the data voltage generated by the data voltage generation circuit.

18. An electro-optical device comprising:
a plurality of scan lines;
a plurality of data lines;
a plurality of pixel electrodes;
a scan line driver circuit which scans the scan lines; and
the driver circuit as defined in claim 16 which drives the data lines.

19. An electro-optical device comprising:
a plurality of scan lines;
a plurality of data lines;
a plurality of pixel electrodes;
a scan line driver circuit which scans the scan lines; and
the driver circuit as defined in claim 17 which drives the data lines.
